(19) United States
(12) Patent Application Publication
(10) Pub. No.: US 2025/0184996 A1
(43) Pub. Date: Jun. 5, 2025

(54) TRANSMISSION PROCESSING METHOD AND APPARATUS AND TERMINAL

(71) Applicant: VIVO MOBILE COMMUNICATION CO., LTD., Dongguan (CN)

(72) Inventors: Zhi LU, Dongguan (CN); Xueming PAN, Dongguan (CN)

(21) Appl. No.: 19/044,772

(22) Filed: Feb. 4, 2025

Related U.S. Application Data
(63) Continuation of application No. PCT/CN2023/110971, filed on Aug. 3, 2023.

(30) Foreign Application Priority Data
Aug. 8, 2022 (CN) 202210946358.8

(51) Int. Cl. H04W 72/1263; H04W 72/0446

(52) U.S. Cl. CPC H04W 72/1263; H04W 72/0446

(57) ABSTRACT

A transmission processing method and apparatus and a terminal are disclosed. The method of embodiments of this application includes: determining, by a terminal, a transmission direction of a first transmission resource based on a first transmission direction of a first transmission, where the first transmission is a transmission configured or scheduled by a network-side device on the first transmission resource; and the first transmission direction is different from a second transmission direction configured for the first transmission resource by the network-side device; or the network-side device has not configured a first transmission direction for the first transmission resource.

### CROSS-REFERENCE TO RELATED APPLICATIONS

This application is a bypass continuation application of International Application No. PCT/CN2023/110971, filed on Aug. 3, 2023, which claims the benefit of and priority to Chinese Patent Application No. 202210946358.8, filed on Aug. 8, 2022, both of which are incorporated herein by reference in their entirety.

### TECHNICAL FIELD

This application pertains to the field of communication technologies, and specifically relates to a transmission processing method and apparatus and a terminal.

### BACKGROUND

In the related art, after a network configures a bandwidth part (BWP) for user equipment (UE), the UE uses uplink resources and downlink resources determined in the BWP for service transmission. However, an uplink traffic volume and a downlink traffic volume of the UE are asymmetrical. In some scenarios, the uplink traffic volume is greater than the downlink traffic volume, while in other scenarios, the downlink traffic volume is greater than the uplink traffic volume. For example, at some times, the downlink traffic volume of the entire system is large, and downlink resources are scarce, but the utilization rate of uplink resources is low with many idle resources.

### BRIEF SUMMARY

Embodiments of this application provide a transmission processing method and apparatus and a terminal.

According to a first aspect, this application provides a transmission processing method, including:
determining, by a terminal, a transmission direction of a first transmission resource based on a first transmission direction of a first transmission, where the first transmission is a transmission configured or scheduled by a network-side device to be sent or received on the first transmission resource; and
the first transmission direction is different from a second transmission direction configured for the first transmission resource by the network-side device; or the network-side device has not configured a first transmission direction for the first transmission resource.

According to a second aspect, this application provides a transmission processing apparatus, applied to a terminal, including:
a first determining module, configured to determine a transmission direction of a first transmission resource based on a first transmission direction of a first transmission, where the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

According to a third aspect, this application provides a terminal, where the terminal includes a processor and a memory, and the memory stores a program or instructions capable of running on the processor, and when the program or instructions are executed by the processor, the steps of the method according to the first aspect are implemented.

According to a fourth aspect, this application provides a terminal, including a processor and a communication interface, where the processor is configured to determine a transmission direction of a first transmission resource based on a first transmission direction of a first transmission, where the first transmission is a transmission configured or scheduled by a network-side device on the first transmission resource.

According to a fifth aspect, this application provides a readable storage medium, where the readable storage medium stores a program or instructions thereon, and when the program or the instructions are executed by a processor, the steps of the method according to the first aspect are implemented.

According to a sixth aspect, this application provides a chip, where the chip includes a processor and a communication interface, the communication interface is coupled to the processor, and the processor is configured to run a program or instructions to implement the method according to the first aspect.

According to a seventh aspect, this application provides a computer program/program product, where the computer program/program product is stored in a storage medium, the computer program/program product is executed by at least one processor to implement the steps of the method according to the first aspect.

### BRIEF DESCRIPTION OF DRAWINGS

FIG. 1 is a structural diagram of a communication system to which embodiments of this application are applicable;

FIG. 2 is a schematic flowchart of a transmission processing method according to an embodiment of this application;

FIG. 3 is a first schematic diagram of a configuration of a first transmission resource according to an embodiment of this application;

FIG. 4 is a first schematic diagram of a first transmission and a position of a first transmission resource according to an embodiment of this application;

FIG. 5 is a second schematic diagram of a first transmission and a position of a first transmission resource according to an embodiment of this application;

FIG. 6 is a third schematic diagram of a first transmission and a position of a first transmission resource according to an embodiment of this application;

FIG. 7 is a fourth schematic diagram of a first transmission and a position of a first transmission resource according to an embodiment of this application;

FIG. 8 is a fifth schematic diagram of a first transmission and a position of a first transmission resource according to an embodiment of this application;

FIG. 9 is a sixth schematic diagram of a first transmission and a position of a first transmission resource according to an embodiment of this application;

FIG. 10 is a seventh schematic diagram of a first transmission and a position of a first transmission resource according to an embodiment of this application;

FIG. 11 is an eighth schematic diagram of a first transmission and a position of a first transmission resource according to an embodiment of this application;

FIG. 12 is a ninth schematic diagram of a first transmission and a position of a first transmission resource according to an embodiment of this application;

FIG. 13 is a schematic diagram of a configuration of a first time window according to an embodiment of this application;

FIG. 14 is a second schematic diagram of a configuration of a first transmission resource according to an embodiment of this application;

FIG. 15 is a tenth schematic diagram of a first transmission and a position of a first transmission resource according to an embodiment of this application;

FIG. 16 is an eleventh schematic diagram of a first transmission and a position of a first transmission resource according to an embodiment of this application;

FIG. 17 is a twelfth schematic diagram of a first transmission and a position of a first transmission resource according to an embodiment of this application;

FIG. 18 is a thirteenth schematic diagram of a first transmission and a position of a first transmission resource according to an embodiment of this application;

FIG. 19 is a fourteenth schematic diagram of a first transmission and a position of a first transmission resource according to an embodiment of this application;

FIG. 20 is a fifteenth schematic diagram of a first transmission and a position of a first transmission resource according to an embodiment of this application;

FIG. 21 is a sixteenth schematic diagram of a first transmission and a position of a first transmission resource according to an embodiment of this application;

FIG. 22 is a seventeenth schematic diagram of a first transmission and a position of a first transmission resource according to an embodiment of this application;

FIG. 23 is a schematic diagram of modules of a transmission processing apparatus according to an embodiment of this application;

FIG. 24 is a structural block diagram of a communication device according to an embodiment of this application; and

FIG. 25 is a structural block diagram of a terminal according to an embodiment of this application.

### DETAILED DESCRIPTION

The following clearly describes the technical solutions in the embodiments of this application with reference to the accompanying drawings in the embodiments of this application. Understandably, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (LTE) or LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communication system.

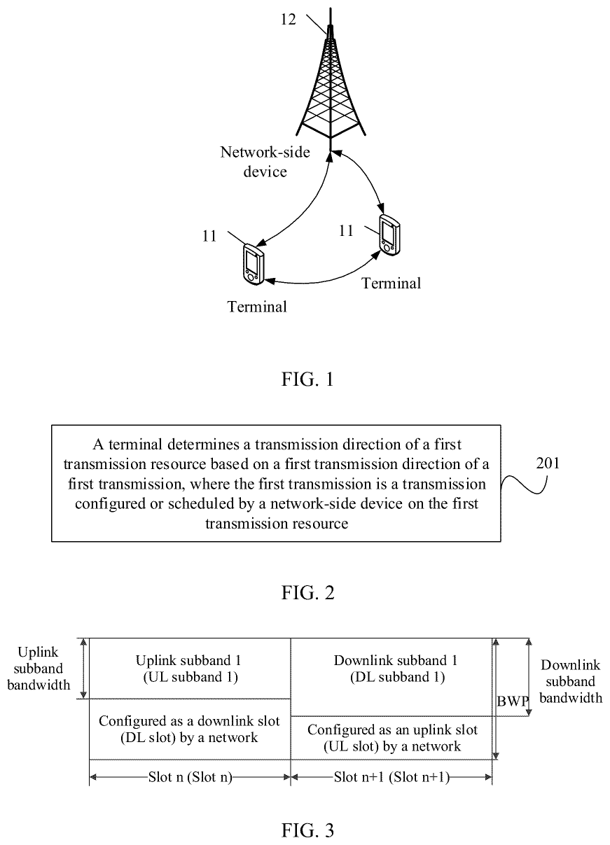

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet personal computer, a laptop computer or notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicular user equipment (VUE), pedestrian user equipment (PUE), smart-home appliance (a smart-home device having a wireless communication function, for example, a refrigerator, a television, a washing machine, or furniture), a game console, a personal computer (PC), a teller machine, or a self-service machine. The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, or the like. It should be noted that the embodiments of this application do not impose any limitation on a specific type of the terminal 11. The network-side device 12 may include an access network device or a core network device, where the access network device may also be called a radio access network device, a radio access network (RAN), a radio access network function, or a radio access network unit. The access network device may include a base station, a wireless local area network (WLAN) access point, or a Wi-Fi node. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (ESS), a home NodeB, a home evolved NodeB, a transmission-reception point (Transmitting Receiving Point, TRP), or another appropriate term in the art. Provided that the same technical effect is achieved, the base station is not limited to a specific technical term. It should be noted that the base station in the NR system is only used as an example in the embodiments of this application for illustration, but a specific type of the base station is not limited.

To enable persons skilled in the art to better understand the embodiments of this application, the following description is provided.

Compared with previous mobile communication systems, future 5G mobile communication systems need to adapt to more diversified scenarios and service requirements. The main scenarios of 5G include enhanced mobile broadband (eMBB), ultra-reliable and low latency communication (ultra-reliable and low latency communications, URLLC), and massive machine type communication (massive machine type of communication, mMTC). These scenarios impose various requirements, such as high reliability, low latency, large bandwidth, and wide coverage on the system.

In NR, the network configures a bandwidth part (BWP) and/or carriers for the UE to perform data transmission. The bandwidth of the UE can dynamically change.

### 1. Slot Format

In LTE, the uplink and downlink configurations are based on slots or subframes, and the uplink and downlink configurations include seven configurations of LTE time division duplex (TDD). In NR, the uplink and downlink configurations are based on symbols,

making the configurations more flexible. The specific configuration procedure is as follows.

(1) First, configure a cell semi-static uplink and downlink configuration.

A higher layer provides a parameter time-division duplex uplink and downlink common configuration (TDD-UL-DL-ConfigurationCommon), and the parameter includes reference subcarrier spacing u and pattern 1 (pattern1), where u is indicated by a reference subcarrier spacing configuration (reference SCS configuration), and pattern 1 further includes:
slot configuration period P ms;
number of slots with only downlink symbols Dslots;
number of downlink symbols Dsym;
number of slots with only uplink symbols Uslots; and
number of uplink symbols Usym; where
a configuration period P=0.625 ms is valid only for 120 kHz subcarrier spacing, a configuration period P=1.25 ms is valid only for 60 kHz subcarrier spacing and 120 kHz subcarrier spacing, and a configuration period P=2.5 ms is valid only for 30 kHz subcarrier spacing, 60 kHz subcarrier spacing, and 120 kHz subcarrier spacing. Thus, the number of slots in one configuration period can be known through the formula S=P*2u. In these slots, the first Dslots slots are downlink slots, followed by Dsym downlink symbols, then Usym uplink symbols, and finally Uslots uplink slots. After uplink and downlink symbols are configured in S slots, the remaining are flexible symbols X.

If both pattern 1 and pattern 2 are configured in the parameter, two different slot formats can be continuously configured, and a parameter form in pattern 2 is similar to that in pattern 1.

(2) Then configure a cell-specific uplink and downlink configuration.

If a higher layer parameter time-division duplex uplink and downlink specific configuration (TDD-UL-DL-ConfigDedicated) is further provided on the basis of a configuration of TDD-UL-DL-ConfigurationCommon, this parameter can be used to configure flexible symbols configured by TDD-UL-DL-ConfigurationCommon. To be specific, the uplink and downlink symbols configured in TDD-UL-DL-ConfigurationCommon cannot be changed, but the flexible symbols can be overridden by TDD-UL-DL-ConfigDedicated.

This parameter provides a series of slot configurations, and provides a slot index and a symbol configuration for each slot configuration. For the slot specified by a slot index:
if symbols=allDownlink (all for downlink), all symbols in the slot are downlink (all symbols in the slot are downlink);
if symbols=allUplink (all for uplink), all symbols in the slot are uplink; and
if symbols=explicit, the number of downlink symbols provides the number of downlink symbols first (nrofDownlinkSymbols provides a number of downlink first).

To be specific, if the symbols are explicit, the parameter nrofDownlinkSymbols provides the number of downlink symbols, and nrofUplinkSymbols provides the number of uplink symbols, with downlink symbols at the front anduplink symbols at the back. If the parameter nrofDownlinkSymbols is not provided, there are no downlink symbols. If nrofUplinkSymbols is not provided, there are no uplink symbols. If there are any remaining symbols after the configuration, the remaining symbols are still flexible symbols X. The reference subcarrier spacing reference SCS configuration in (2) is the same as that in (1).

(3) Dynamic downlink control information (DCI) uplink and downlink configuration.

The uplink and downlink configuration implemented by dynamic DCI is realized through DCI format 2-0, or directly through uplink and downlink data scheduling of DCI formats 0-0, 0-1, 1-0, and 1-1. DCI format 2-0 is specifically used for slot format indicator (SFI). SFI mainly realizes the periodic frame structure configuration based on a slot format that can be supported by a single slot, that is, from the receipt of DCI format 2-0, lasting for a number of slots equal to a physical downlink control channel (PDCCH) monitoring period, these slots are configured according to the SFI indication in this DCI. The maximum number of formats supported by a single slot is 256, and 56 formats have been standardized.

### 2. Full Duplex

For unpaired spectrum (TDD configuration) in NR, the UL-DL BWP bandwidth and SCS may be different.

For one DL slot (configured by the foregoing slot configuration parameters), the network configures a DL BWP for the UE, and for a UL slot, the network configures a UL BWP for the UE.

For full duplex scenarios, there are three cases:
Case 1: Configure DL BWP for the UE.
Case 2: Configure uplink resources (UL resources) for the UE in the DL BWP, such as subbands, and thus the DL BWP may be considered to have subband full duplex (SBFD) resources.
Case 3: Configure downlink resources (DL resources) for the UE in the UL BWP, such as subbands, and thus the UL BWP may be considered to have SBFD resources.

For one UL slot (configured by the foregoing parameters), there are the following three cases.
Case 1: Configure UL BWP for the UE.
Case 2: Configure DL resources (such as subband) for the UE in the UL BWP, and thus the UL BWP may be considered to have SBFD resources.
Case 3: Configure UL resources (such as subband) for the UE in the DL BWP, and thus the DL BWP may be considered to have SBFD resources.

The following describes in detail a transmission processing method provided in the embodiments of this application by using some embodiments and application scenarios thereof with reference to the accompanying drawings.

As shown in FIG. 2, an embodiment of this application provides a transmission processing method, including the following step.

Step 201: A terminal determines a transmission direction of a first transmission resource based on a first transmission direction of a first transmission, where the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

In this embodiment of this application, the first transmission is an uplink transmission dynamically scheduled or semi-statically configured, and the first transmission resource is a downlink subband semi-statically configured; and optionally, the downlink subband is a downlink subband in an uplink slot; or
the first transmission is a downlink transmission dynamically scheduled or semi-statically configured, and the first transmission resource is an uplink subband semi-statically configured; and optionally, the uplink subband is an uplink subband in a downlink slot; or
the first transmission is an uplink transmission dynamically scheduled or semi-statically configured, and the first transmission resource is a downlink slot or downlink symbol semi-statically configured; and optionally, the downlink slot or downlink symbol includes only a downlink subband (including no uplink subband); or
the first transmission is a downlink transmission dynamically scheduled or semi-statically configured, and the first transmission resource is an uplink slot or uplink symbol semi-statically configured; optionally, the uplink slot or uplink symbol includes only an uplink subband (including no downlink subband).

The first transmission direction includes an uplink transmission direction or a downlink transmission direction. The transmission direction of the first transmission resource includes an uplink transmission direction or a downlink transmission direction. In this embodiment of the application, the terminal may perform

transmission according to a first rule or a second rule.

The first rule includes at least one of the following:
a dynamically scheduled uplink transmission may be transmitted on a semi-statically configured DL subband; and
a dynamically scheduled downlink transmission may be transmitted on a semi-statically configured UL subband.

The first rule may be prescribed by a protocol or configured by a network, or configured by a network according to a capability reported by a terminal. For example, if the terminal supports dynamically scheduled uplink and/or downlink transmission that can appear on a semi-statically configured DL or UL subband, the network configures the terminal to use the first rule.

The second rule includes at least one of the following:
a semi-static uplink transmission may be transmitted on a semi-statically configured DL subband; and
a semi-static downlink transmission may be transmitted on a semi-statically configured UL subband.

The second rule may be prescribed by a protocol or configured by a network, or configured by a network according to a capability reported by a terminal. For example, if the terminal supports semi-static uplink and/or downlink transmission with a certain configuration parameter that may appear on a semi-statically configured DL or UL subband, the network configures the terminal to use the second rule.

In addition, in this embodiment of the application, the slot types to which the first rule or the second rule applies can also be configured. For example, the applicable slot types include: a semi-statically configured DL slot, or a semi-statically configured UL slot, or a dynamically indicated DL slot, or a dynamically indicated UL slot, or a flexible slot or symbol.

In this embodiment of this application, the terminal determines a transmission direction of a first transmission resource based on a first transmission direction of a first transmission, where the first transmission is a transmission configured or scheduled by a network-side device on the first transmission resource. In this embodiment of this application, the transmission direction of the first transmission resource may be flexibly determined based on the first transmission direction of the first transmission, rather than being a fixed transmission direction. In this way, the transmission direction of the first transmission resource may be flexibly adjusted according to a service, increasing the resource utilization rate.

Optionally, a network-side device may pre-configure the transmission direction of the first transmission resource, and then, in a case that the first transmission direction of the first transmission conflicts with (differs from) the pre-configured transmission direction of the network-side device, change the pre-configured transmission direction of the first transmission resource based on the transmission direction of the first transmission.

Optionally, in a first implementation, that a terminal determines a transmission direction of a first transmission resource based on a first transmission direction of a first transmission includes:
in a case that the first transmission direction is different from the second transmission direction, the terminal determines a transmission direction of a first part of the first transmission resource as the first transmission direction, and determines a transmission direction of a second part of the first transmission resource as the second transmission direction; where
the first part of the resource is a resource, overlapping the first transmission, in the first transmission resource, and the second part of the resource is a resource, not overlapping the first part of the resource, in the first transmission resource.

It should be noted that the first part of the resource may be an RE that overlaps with the first transmission in the first transmission resource, or may be an orthogonal frequency division multiplexing (OFDM) symbol that at least partially overlaps with the first transmission in the first transmission resource.

In this embodiment of this application, the first transmission resource may be a resource with SBFD, or may be a resource without SBFD.

The second transmission direction may be a transmission direction of a slot and/or symbol configured by the network through TDD-UL-DL-ConfigurationCommon or TDD-UL-DL-ConfigurationDedicated.

Optionally, after the determining a transmission direction of a first part of the first transmission resource as the first transmission direction, the method further includes:
the terminal performs the first transmission on the first transmission resource.

Optionally, in the foregoing first implementation, after the determining a transmission direction of a first part of the first transmission resource as the first transmission direction, the method further includes:
the terminal determines that the scheduling information or configuration information of the first transmission is valid. In other words, the first transmission is a valid transmission.

Herein, that the terminal determines that the first transmission is a valid transmission can be understood as follows: the terminal does not regard a case that the first transmission direction is different from the second transmission direction as an error case, and the terminal receives the complete first transmission (the part that the first transmission overlaps with the first transmission resource is considered as the first transmission).

Optionally, after the terminal determines that the first transmission is a valid transmission, the method further includes:
the terminal performs the first transmission on the first transmission resource.

In addition, in this embodiment of this application, in the case that the first transmission direction is different from the second transmission direction, rate matching processing or puncturing processing may also be performed on the first part of the resource

An embodiment of this application further provides an information processing method, including:
after receiving a first transmission configured or scheduled by a network-side device on a first transmission resource, a terminal performs the first transmission on the first transmission resource; where
the first transmission direction is different from a second transmission direction configured for the first transmission resource by the network-side device; or the network-side device has not configured a first transmission direction for the first transmission resource.

In this embodiment, when performing the first transmission on the first transmission resource, the terminal determines the transmission direction of the first transmission resource based on the first transmission direction of the first transmission. Specifically, the specific implementation of determining the transmission direction of the first transmission resource based on the first transmission direction of the first transmission is the same as that described in the foregoing embodiments, and details are not repeated herein. In a first embodiment of this application, as shown in FIG. 3, a network configures a transmission direction of a slot and/or symbol for UE through TDD-UL-DL-ConfigurationCommon or TDD-UL-DL-ConfigurationDedicated. For example, for slot n, the network configures a DL slot for the UE, and for slot n+1, the network configures a UL slot for the UE (for simplicity, flexible slots and symbols are not shown in the figure). For a full duplex operation, the network may configure a semi-statically or dynamically indicated UL subband in the DL slot or a semi-statically or dynamically indicated DL subband in the UL slot for the UE. The dynamically indicated subband may be indicated through group common dedicated signaling, for example, indicating positions and transmission directions of subbands in one BWP for a group of UEs.

Semi-statically configured subbands are used as an example. The network may configure some or all DL transmissions scheduled by a dynamic scheduling grant (carried by DCI), such as a physical downlink shared channel (PDSCH), to be transmitted on a semi-statically configured UL subband in slot n (DL slot). To be specific, when a UE receives a PDSCH scheduled by dynamic DCI, if the PDSCH partially or completely overlaps with a semi-statically configured UL subband, the PDSCH can still be considered a valid PDSCH. If the physical uplink shared channel (PUSCH) scheduled by the network overlaps with a downlink subband in slot n (DL slot), the transmission of the PUSCH is dropped.

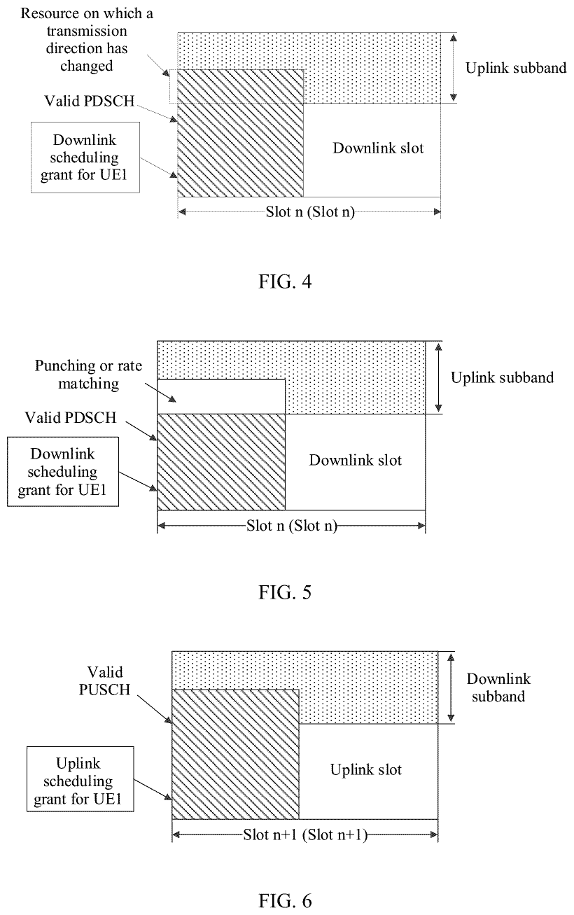

The valid PDSCH can be understood as: as shown in FIG. 4, the UE does not consider this case as an error case, and the UE receives the complete PDSCH (meaning that a part of which the PDSCH overlaps with the UL subband (that is, overlaps with an RE in the UL subband) is considered as the PDSCH).

Optionally, if the PDSCH partially or completely overlaps with a semi-statically configured UL subband in slot n (DL slot), as shown in FIG. 5, the UE performs rate matching reception on the overlapping part between the PDSCH and the UL subband, or the UE performs puncture reception on the overlapping part between the PDSCH and the UL subband.

Optionally, in this first embodiment, if a CSI Reference Signal (CSI-RS) corresponding to aperiodic channel state information (CSI) reporting triggered by the DCI overlaps with a semi-statically configured UL subband, the CSI-RS may be considered as a valid CSI-RS, and the CSI report may be calculated based on the measurement of this CSI-RS.

Similarly, when a UE receives a PUSCH scheduled by dynamic DCI, if the PUSCH overlaps with a semi-statically configured or dynamically indicated DL subband in slot n+1 (UL slot), the PUSCH may be considered as a valid PUSCH. For example, if a dynamically scheduled PDSCH overlaps with the UL subband in slot n+1 (UL slot), the transmission of this PDSCH is dropped.

The valid PUSCH can be understood as: as shown in FIG. 6, the UE does not consider this case as an error case. The UE sends the complete PUSCH (an overlapping part between the PUSCH and the DL subband (that is, overlapping with REs in the DL subband) is considered as the PUSCH) at the scheduled frequency-domain position.

Optionally, if the PUSCH overlaps with a semi-statically configured or dynamically indicated DL subband, the UE may also perform a rate matching operation on the overlapping part of the PUSCH and the DL subband, or
the UE may perform a puncture operation on the overlapping part of the PUSCH and the DL subband.

Optionally, if a sounding reference signal (SRS) or physical uplink control channel (PUCCH)/physical random access channel (PRACH) or random access response (RAR) uplink grant UL grant scheduled PUSCH triggered by the DCI overlaps with a semi-statically configured DL subband, the SRS, the PUCCH, and the like may be considered valid. Note that the SRS or PUCCH/PRACH or RAR UL grant scheduled PUSCH triggered by the DCI may also be applied to the following embodiments.

In a second embodiment of this application, as shown in FIG. 3, a network configures a transmission direction of a slot and/or symbol for UE through TDD-UL-DL-ConfigurationCommon or TDD-UL-DL-ConfigurationDedicated. For example, for slot n, the network configures a DL slot for the UE, and for slot n+1, the network configures a UL slot for the UE (for simplicity, flexible slots and symbols are not shown in the figure). For full duplex operation, the network may configure semi-static or dynamically indicated UL subbands or DL subbands for the UE. The dynamically indicated subband may be indicated through group common dedicated signaling, for example, indicating positions and transmission directions of subbands in one BWP for a group of UEs.

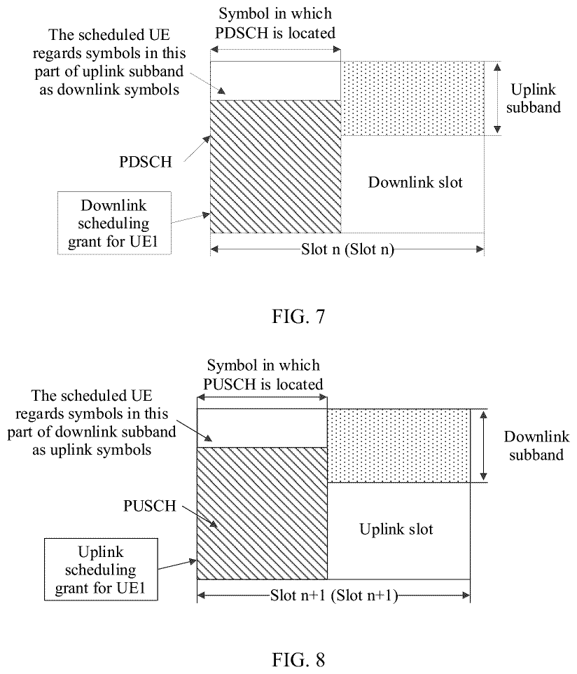

Furthermore, the network may also configure the following information: when a UE receives a dynamically scheduled PDSCH, if the PDSCH overlaps with a semi-statically configured UL subband, as shown in FIG. 7, for the scheduled UE, symbols in the UL subband that overlap with the PDSCH are considered DL symbols, that is, time-domain resources (in a unit of symbol) in which the PDSCH is located in the uplink subband are all determined to be downlink resources.

Optionally, the UE considers that DL-related configurations such as physical downlink control channel (PDCCH) monitoring, semi-persistent scheduling (SPS), CSI reference signal (CSI-RS) configured by the network for the UE are valid in these subbands, and the UE performs corresponding DL reception and measurement in these subbands.

Similarly, as shown in FIG. 8, when a UE receives a dynamically scheduled PUSCH, if the PUSCH overlaps with a semi-statically configured DL subband, the scheduled UE considers the symbols in the DL subband that overlap with the PUSCH as UL symbols, meaning that the time-domain resources (in units of symbols) in which the PUSCH is located in the downlink subband are all determined to be uplink resources.

Optionally, the UE considers that UL-related configurations such as sounding reference signal (SRS), PUCCH, and configured grant PUSCH (CG PUSCH) configured by the network for the UE are valid in these subbands, and the UE performs corresponding UL transmission and measurement in these subbands.

In a third embodiment of this application, when a UE receives a dynamically scheduled PDSCH, if the PDSCH does not overlap with a semi-statically configured UL subband, or when a UE receives a dynamically scheduled PUSCH, if the PUSCH does not overlap with a semi-statically configured DL subband, the UE still considers a transmission direction of the UL subband to be UL.

Optionally, in the foregoing first implementation, that a terminal determines a transmission direction of a first transmission resource based on a first transmission direction of a first transmission includes:
the terminal obtains first indication information, where the first indication information is used to indicate whether the terminal is allowed to change the transmission direction of the first transmission resource based on the first transmission; and
in a case that the first indication information indicates that the terminal is allowed to change the transmission direction of the first transmission resource based on the first transmission, the terminal determines the transmission direction of the first transmission resource based on the first transmission direction.

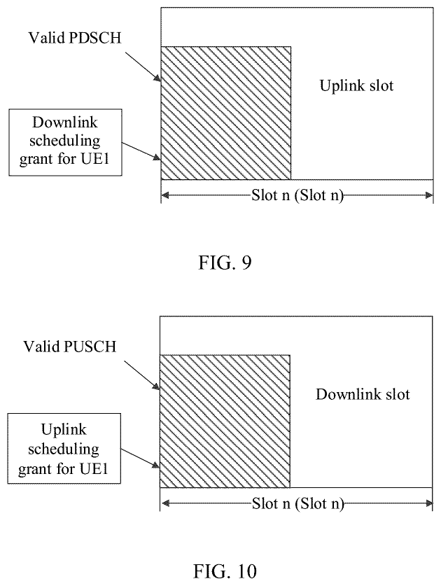

In a fourth embodiment of this application, the network configures that a UE can change transmission directions of slots and/or symbols configured for the UE, through dynamic scheduling, with regard to TDD-UL-DL-ConfigurationCommon or TDD-UL-DL-ConfigurationDedicated. When a UE receives a dynamically scheduled PDSCH, as shown in FIG. 9, if the PDSCH overlaps with UL slots or symbols configured by TDD-UL-DL-ConfigurationCommon or TDD-UL-DL-ConfigurationDedicated, the PDSCH is valid for the scheduled UE. The meaning of the valid PDSCH is the same as that of the valid PDSCH in the foregoing first embodiment, and details are not repeated herein.

Alternatively, as shown in FIG. 10, when a UE receives a dynamically scheduled PUSCH, if the PUSCH overlaps with DL slots or symbols configured by TDD-UL-DL-ConfigurationCommon or TDD-UL-DL-ConfigurationDedicated, the PUSCH is valid for the scheduled UE. The meaning of the valid PUSCH is the same as that of the valid PUSCH in the foregoing first embodiment, and details are not repeated herein.

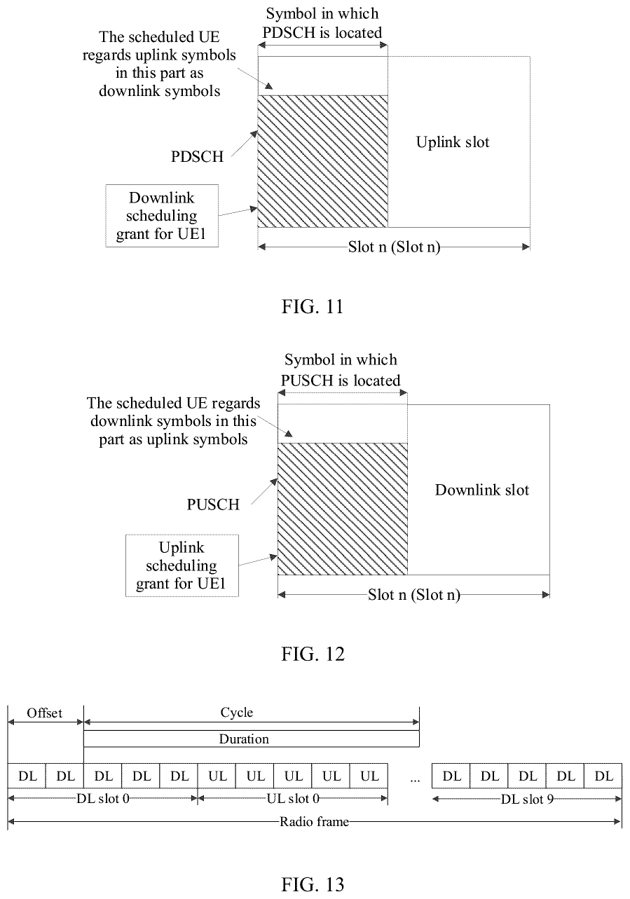

In a fifth embodiment of this application, as shown in FIG. 11, the network configures slot n as an uplink slot. When a UE receives a dynamically scheduled PDSCH, if the PDSCH overlaps with UL slots or symbols configured by TDD-UL-DL-ConfigurationCommon or TDD-UL-DL-ConfigurationDedicated, the symbols in which the PDSCH is located are considered DL for the scheduled UE, meaning that time-domain resources (in a unit of symbols) in which the PDSCH is located in the uplink slot are all determined to be downlink resources.

Optionally, for the symbols in which the PDSCH is located, the UE considers that DL-related configurations such as PDCCH monitoring, semi-persistent scheduling (SPS), CSI reference signal (CSI-RS) configured by the network for the UE are valid in these symbols, and the UE performs corresponding DL reception and measurement in these symbols.

As shown in FIG. 12, the network configures slot n as a downlink slot. When a UE receives a dynamically scheduled PUSCH, if the PUSCH overlaps with DL slots or symbols configured by TDD-UL-DL-ConfigurationCommon or TDD-UL-DL-ConfigurationDedicated, the symbols in which the PUSCH is located are considered

UL for the scheduled UE, meaning that time-domain resources (in a unit of symbol) in which the PUSCH is located in the downlink slot are all determined to be uplink resources.

Optionally, for the symbols in which the PUSCH is located, the UE considers that UL-related configurations such as sounding reference signal (SRS),

PUCCH, configured grant PUSCH (CG PUSCH) configured by the network for the UE are valid in these symbols, and the UE performs corresponding UL transmission and measurement in these symbols.

Optionally, in the foregoing first implementation, that a terminal determines a transmission direction of a first transmission resource based on a first transmission direction of a first transmission includes:
the terminal determines, based on the first transmission direction of the first transmission, the transmission direction of the first transmission resource within a first time window configured by a network-side device.

Specifically, the terminal first obtains a period and offset information of the first time window, and then determines the first time window according to the period and offset information.

Optionally, the network may configure a duration length, that is, the first time window, during which the dynamically scheduled uplink or downlink transmission can override the transmission direction of the semi-statically configured DL or UL subband; and specifically configure a length and offset of the first time window; or configure a time window (the foregoing first time window) during which the semi-static uplink or downlink transmission with a certain configuration parameter can override the transmission direction of the semi-statically configured DL or UL subband, and specifically configure a duration length and offset of the first time window.

One configuration of the first time window is shown in FIG. 13. Offset by x slots or symbols from a slot in which the dynamically scheduled uplink or downlink transmission or the semi-static uplink or downlink transmission with a certain configuration parameter is located and a duration length of Y ms are configured. Then, within this time window, transmission directions of subbands, slots, or symbols may be determined according to the foregoing rule.

Optionally, the length of the foregoing time window may also be defined as a time interval. For example, offset by x slots or symbols from a slot in which the dynamically scheduled uplink or downlink transmission or the semi-static uplink or downlink transmission with a certain configuration parameter is located and an interval of Yms take effect. Then, in the time slots or symbols at the interval of Y ms, transmission directions of subbands, slots, or symbols are determined according to the foregoing rule.

Optionally, the method of this embodiment of this application further includes:
the terminal determines the transmission direction of the first transmission resource, based on the transmission direction configured by the network-side device for the first transmission resource, outside the first time window configured by the network-side device.

In a second implementation, that a terminal determines a transmission direction of a first transmission resource based on a first transmission direction of a first transmission includes:
the terminal determines a transmission direction of a time-domain resource after a first transmission symbol in the first transmission resource as the first transmission direction, where the first transmission symbol is a starting symbol of the first transmission; or
the terminal determines a transmission direction of a time-domain resource after a second transmission symbol in the first transmission resource as the first transmission direction, where the second transmission symbol is a starting symbol of a physical downlink control channel PDCCH that schedules the first transmission; or
the terminal determines a transmission direction of a time-domain resource after a first transmission position in the first transmission resource as the first transmission direction, where the first transmission position is a position that is a first duration after the second transmission symbol. The first duration may be prescribed by a protocol or configured by a network.

In this second implementation, the network may configure or indicate slots with SBFD, without explicitly indicating all or part of configuration information of a subband, and the terminal determines the transmission direction in these slots based on the scheduling or semi-static configuration of the network device.

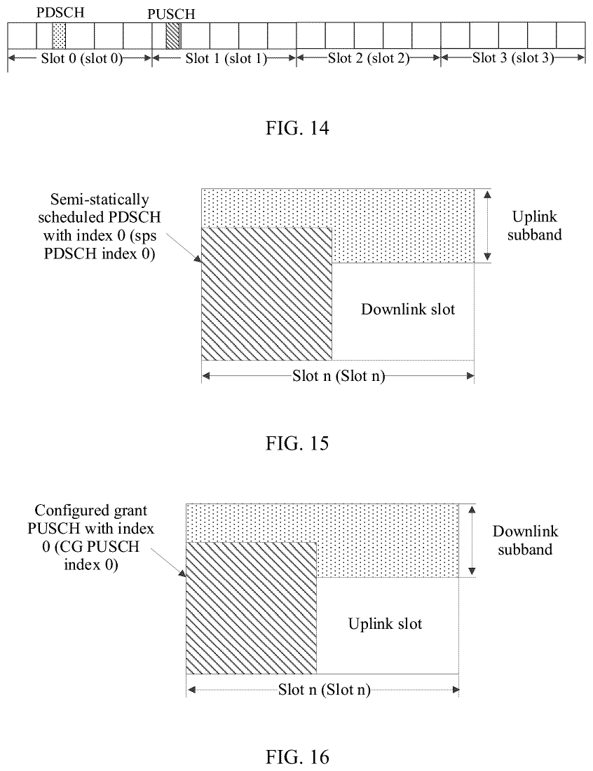

In a sixth embodiment of this application, as shown in FIG. 14, the network configures slot 0 and slot 1 as slots with non-overlapping half-duplex subbands, and slot 2 and slot 3 as slots without non-overlapping half-duplex subbands. For slots without non-overlapping half-duplex subbands, their transmission direction is determined according to TDD-UL-DL-ConfigurationCommon or TDD-UL-DL-ConfigurationDedicated.

Assuming that the network schedules a PDSCH for a UE in slot 0, the UE considers slot 0 to be a DL slot.

Specifically, the symbols located after the starting symbol of the PDSCH may be considered DL symbols (the network may configure the UE to consider the symbols located after the starting symbol of the PDSCH to the ending symbol of the slot as downlink symbols, or the network may configure the UE to consider N slots located after the starting symbol of the PDSCH as downlink symbols); or
symbols located after the starting symbol of the PDCCH that carries the DCI scheduling the PDSCH are considered DL symbols (the network may configure the UE to consider the symbols located from the starting symbol of the PDCCH to the ending symbol of the slot in which the scheduled PDSCH is located as downlink symbols, or the network may configure the UE to consider N slots located after the starting symbol of the PDCCH as downlink symbols); or
symbols located after T time of the starting symbol of the PDCCH that carries the DCI scheduling the PDSCH are considered DL symbols, where T may be configured by the network; and
assuming that the network schedules a PUSCH for a UE in slot 1, the UE considers slot 1 to be a UL slot.

Specifically, the symbols located after the starting symbol of the PUSCH may be considered UL symbols (the network may configure the UE to consider the symbols located after the starting symbol of the PUSCH to the ending symbol of the slot in which the PUSCH is located as uplink symbol, or the network may configure N slots located after the starting symbol of the PUSCH as uplink symbol); or
symbols located after the ending symbol of the PDCCH that carries the DCI scheduling the PUSCH are considered UL symbols (the network may configure the UE to consider the symbols located after the ending symbol of the PDCCH to the ending symbol of the slot in which the PUSCH is located as uplink symbols, or the network may configure N slots located after the ending symbol of the PDCCH as uplink symbols); or
symbols located after T time of the ending symbol of the PDCCH that carries the DCI scheduling the PUSCH are considered UL symbols (the network may configure the UE to consider symbols located after T time of the ending symbol of the PDCCH as uplink symbols), where T may be configured by the network, such as PUSCH preparation time (Tproc,2).

Furthermore, if the UE determines a slot or symbol as a DL slot or symbol, the UE considers DL-related parameters, such as SPS, CSI-RS, configured by the network for the UE to be valid in this slot or symbol. The UE performs corresponding DL reception and measurement in this slot or symbol.

If the UE determines a slot as a UL slot or symbol, the UE considers UL-related parameters, such as SRS, PUCCH, and CG PUSCH, configured by the network for the UE to be valid in this slot or symbol, and the UE performs corresponding UL transmission and measurement in this slot or symbol.

Optionally, the first transmission in the foregoing first and second implementations is a transmission with a specific transmission parameter. For example, the specific transmission parameter may be a specific index or specific priority.

In a seventh embodiment of this application, the network may configure a certain SPS or CG configuration that may conflict with the transmission direction of the semi-statically configured subband or conflict with the transmission direction configured by TDD-UL-DL-ConfigurationCommon or TDD-UL-DL-ConfigurationDedicated.

For example, as shown in FIG. 15, the network configures a UE with a semi-static scheduled PDSCH with index 0 (sps PDSCH index 0) that may overlap with a semi-statically configured UL subband. This semi-static subband is configured by RRC, or a high-priority SPS PDSCH may overlap with a semi-statically configured UL subband. At this time, the sps PDSCH is a valid SPS PDSCH.

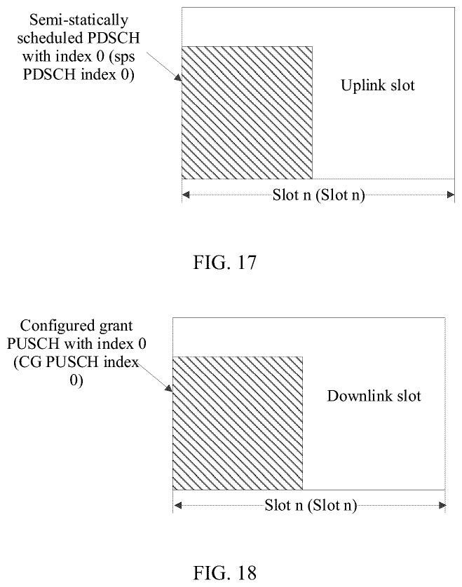

For example, as shown in FIG. 16, the network configures a UE with a configured grant PUSCH with index 0 (CG PUSCH index 0) that may overlap with a semi-statically configured DL subband. This semi-static subband is configured by RRC; or a high-priority CG PUSCH may overlap with a semi-statically configured DL subband. This CG PUSCH is a valid CG PUSCH.

For example, as shown in FIG. 17, the network configures a UE with SPS PDSCH index 0 or a high-priority SPS PDSCH that may overlap with the UL slot or symbol configured by TDD-UL-DL-ConfigurationCommon or TDD-UL-DL-ConfigurationDedicated. For this SPS PDSCH, the UE considers it valid.

For example, as shown in FIG. 18, the network configures a UE with CG PUSCH index 0 or a high-priority CG that may overlap with the DL slot or symbol configured by TDD-UL-DL-ConfigurationCommon or TDD-UL-DL-ConfigurationDedicated. For this CG PUSCH, the scheduled UE considers it valid.

Optionally, the network may configure an SPS or CG configuration with a certain transmission parameter that may conflict with a transmission direction of a semi-statically configured subband or a transmission direction configured by TDD-UL-DL-ConfigurationCommon or TDD-UL-DL-ConfigurationDedicated, and transmission directions of symbols in which the SPS or CG is located are the same as that of the SPS or CG.

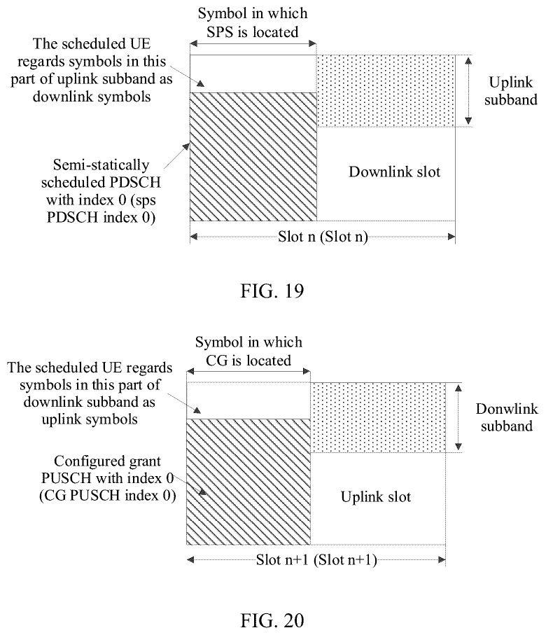

For example, as shown in FIG. 19, the network configures a UE with sps PDSCH index 0 or a high-priority sps PDSCH that may conflict with a semi-statically configured UL subband, where the semi-statically subband is configured by RRC. In addition, symbols in which the sps PDSCH with index 0 or high-priority sps PDSCH is located in the uplink subband are DL symbols.

For example, as shown in FIG. 20, the network configures a UE with CG PUSCH index 0 or a high-priority CG PUSCH that may conflict with a semi-statically configured DL subband. This semi-static subband is configured by RRC; and symbols in which the CG PUSCH with index 0 or high-priority CG PUSCH is located are UL symbols.

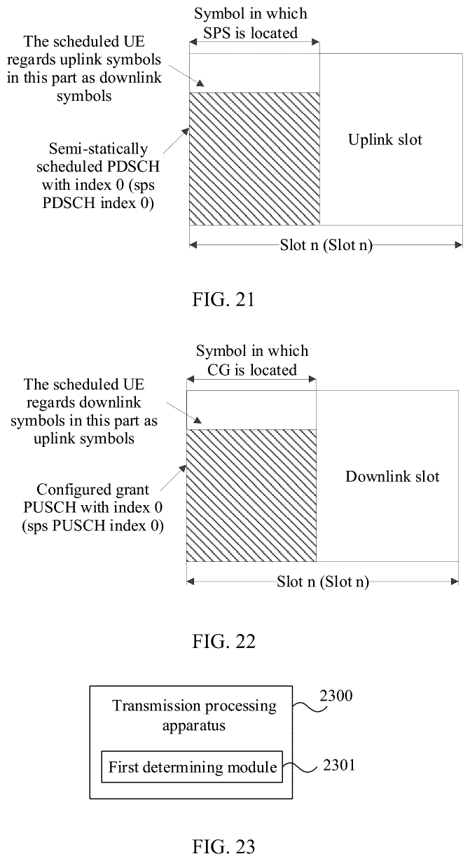

For example, as shown in FIG. 21, the network configures a UE with SPS PDSCH with index 0 or a high-priority SPS PDSCH that may overlap with a UL slot or symbol configured by TDD-UL-DL-ConfigurationCommon or TDD-UL-DL-ConfigurationDedicated. For this SPS PDSCH, the UE considers it valid, and symbols in which the sps PDSCH with index 0 or high-priority SPS PDSCH is located are DL symbols.

For example, as shown in FIG. 22, the network configures a UE with CG PUSCH with index 0 or a high-priority CG PUSCH that may overlap with a DL slot or symbol configured by TDD-UL-DL-ConfigurationCommon or TDD-UL-DL-ConfigurationDedicated. For this CG PUSCH, the UE considers it valid, and symbols in which the CG PUSCH with index 0 or high-priority CG PUSCH is located are UL symbols.

Optionally, the foregoing examples are not only for semi-statically configured subbands, but also for subbands dynamically indicated by group common DCI.

In addition, in this embodiment of this application, if a dynamically scheduled PUSCH or the PUSCH with a certain configuration parameter overlaps with a synchronization signal/physical broadcast channel signal block (or synchronization signal block) (Synchronization Signal and PBCH block, SSB), control resource set

(CORESET) #0 in a DL slot/symbol or DL subband, the PUSCH performs a rate matching or puncture operation.

In this embodiment of this application, the terminal determines a transmission direction of a first transmission resource based on a first transmission direction of a first transmission, where the first transmission is a transmission configured or scheduled by a network-side device on the first transmission resource. In this embodiment of this application, the transmission direction of the first transmission resource may be flexibly determined based on the first transmission direction of the first transmission, rather than being a fixed transmission direction. In this way, the transmission direction of the first transmission resource may be flexibly adjusted according to a service, increasing the resource utilization rate. In addition, in this embodiment of this application, the delay and performance of the TDD system can be significantly changed by configuring full duplex, which is conducive to the transmission of low-latency services.

The transmission processing method according to this embodiment of this application may be executed by a transmission processing apparatus. In this embodiment of this application, assuming that the transmission processing apparatus performs the transmission processing method, the transmission processing apparatus provided in this embodiment of this application is described.

As shown in FIG. 23, an embodiment of this application provides a transmission processing apparatus 2300, applied to a terminal and including:
a first determining module 2301, configured to determine a transmission direction of a first transmission resource based on a first transmission direction of a first transmission, where the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

Optionally, the first transmission is an uplink transmission dynamically scheduled or semi-statically configured, and the first transmission resource is a downlink subband semi-statically configured; or
the first transmission is a downlink transmission dynamically scheduled or semi-statically configured, and the first transmission resource is an uplink subband semi-statically configured; or
the first transmission is an uplink transmission dynamically scheduled or semi-statically configured, and the first transmission resource is a downlink slot or downlink symbol semi-statically configured; or
the first transmission is a downlink transmission dynamically scheduled or semi-statically configured, and the first transmission resource is an uplink slot or uplink symbol semi-statically configured.

Optionally, the first determining module is configured to: in a case that the first transmission direction is different from the second transmission direction, determine a transmission direction of a first part of the first transmission resource as the first transmission direction, and determine a transmission direction of a second part of the first transmission resource as the second transmission direction; where
the first part of the resource is a resource, overlapping the first transmission, in the first transmission resource, and the second part of the resource is a resource, not overlapping the first part of the resource, in the first transmission resource.

Optionally, the apparatus of this embodiment of this application further includes a first transmission module, configured to perform the first transmission on the first transmission resource after the first determining module determines a transmission direction of a first part of the first transmission resource as the first transmission direction.

Optionally, the first determining module includes:
a first obtaining sub-module, configured to obtain first indication information, where the first indication information is used to indicate whether the terminal is allowed to change the transmission direction of the first transmission resource based on the first transmission; and
a first determining sub-module, configured to: in a case that the first indication information indicates that the terminal is allowed to change the transmission direction of the first transmission resource based on the first transmission, determine the transmission direction of the first transmission resource based on the first transmission direction of the first transmission.

Optionally, the first determining module is configured to determine, based on the first transmission direction of the first transmission, the transmission direction of the first transmission resource within a first time window configured by a network-side device.

Optionally, the apparatus of this embodiment of this application further includes:
a second determining module, configured to determine the transmission direction of the first transmission resource, based on the transmission direction configured by the network-side device for the first transmission resource, outside the first time window configured by the network-side device.

Optionally, the first determining module is configured to:
determine a transmission direction of a time-domain resource after a first transmission symbol as the first transmission direction, where the first transmission symbol is a starting symbol of the first transmission;
determine a transmission direction of a time-domain resource after a second transmission symbol as the first transmission direction, where the second transmission symbol is a starting symbol of a physical downlink control channel PDCCH that schedules the first transmission; or
determine a transmission direction of a time-domain resource after a first transmission position as the first transmission direction, where the first transmission position is a position that is a first duration after the second transmission symbol.

In this embodiment of this application, the terminal determines a transmission direction of a first transmission resource based on a first transmission direction of a first transmission, where the first transmission is a transmission configured or scheduled by a network-side device on the first transmission resource.

In this embodiment of this application, the transmission direction of the first transmission resource may be flexibly determined based on the first transmission direction of the first transmission, rather than being a fixed transmission direction. In this way, the transmission direction of the first transmission resource may be flexibly adjusted according to the service, increasing the resource utilization rate.

The transmission processing apparatus in this embodiment of this application may be an electronic device, for example, an electronic device with an operating system, or may be a component in an electronic device, for example, an integrated circuit or a chip. The electronic device may be a terminal or may be another device except the terminal. For example, the terminal may include but is not limited to the types of the terminal 11 listed above, and the another device may be a server, a network attached storage (NAS), or the like, which are not specifically limited in the embodiments of this application.

The transmission processing apparatus provided in this embodiment of this application is capable of implementing the processes implemented in the method embodiments in FIG. 2 and FIG. 22, with the same technical effects achieved. To avoid repetition, details are not described herein again.

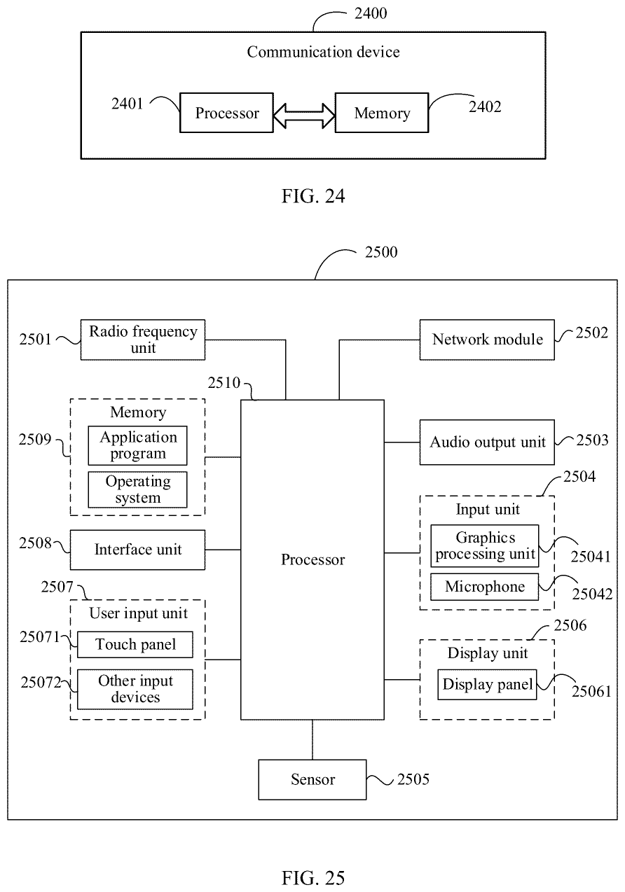

Optionally, as shown in FIG. 24, an embodiment of this application further provides a communication device 2400 including a processor 2401 and a memory 2402, where a program or instructions are stored in the memory 2402 and capable of running on the processor 2401. For example, in a case that the communication device 2400 is a terminal, when the program or instructions are executed by the processor 2401, the steps of the foregoing embodiment of the transmission processing method are implemented, with the same technical effects achieved. To avoid repetition, details are not described herein again.

An embodiment of this application further provides a terminal, including a processor and a communication interface, where the processor is configured to determine a transmission direction of a first transmission resource based on a first transmission direction of a first transmission, where the first transmission is a transmission configured or scheduled by a network-side device on the first transmission resource; and the first transmission direction is different from a second transmission direction configured for the first transmission resource by the network-side device; or the network-side device has not configured a first transmission direction for the first transmission resource.

This terminal embodiment corresponds to the foregoing method embodiment on the terminal side. All implementations in the foregoing method embodiment may be applicable to this terminal embodiment, with the same technical effects achieved.

Specifically, FIG. 25 is a schematic structural diagram of hardware of a terminal for implementing embodiments of this application.

The terminal 2500 includes, but is not limited to, at least some of components such as a radio frequency unit 2501, a network module 2502, an audio output unit 2503, an input unit 2504, a sensor 2505, a display unit 2506, a user input unit 2507, an interface unit 2508, a memory 2509, and a processor 2510.

Persons skilled in the art can understand that the terminal 2500 may further include a power supply (for example, a battery) for supplying power to the components. The power supply may be logically connected to the processor 2510 through a power management system. In this way, functions such as charge management, discharge management, and power consumption management are implemented by using the power management system.

The structure of the terminal shown in FIG. 25 does not constitute any limitation on the terminal. The terminal may include more or fewer components than shown in the figure, or a combination of some components, or the components disposed differently. Details are not described herein again.

It should be understood that in this embodiment of this application, the input unit 2504 may include a graphics processing unit (GPU) 25041 and a microphone 25042. The graphics processing unit 25041 processes image data of a static picture or a video that is obtained by an image capture apparatus (for example, a camera) in a video capture mode or an image capture mode. The display unit 2506 may include a display panel 25061, and the display panel 25061 may be configured in a form of a liquid crystal display, an organic light-emitting diode, and the like. The user input unit 2507 includes at least one of a touch panel 25071 and other input devices 25072. The touch panel 25071 is also referred to as a touchscreen. The touch panel 25071 may include two parts: a touch detection apparatus and a touch controller. The other input devices 25072 may include but are not limited to a physical keyboard, a function key (for example, a volume control key or a power on/off key), a trackball, a mouse, a joystick, and the like. Details are not described herein.

In this embodiment, after receiving downlink data from a network-side device, the radio frequency unit 2501 may transmit the downlink data to the processor 2510 for processing. In addition, the radio frequency unit 2501 may transmit uplink data to the network-side device.

Generally, the radio frequency unit 2501 includes but is not limited to an antenna, an amplifier, a transceiver, a coupler, a low noise amplifier, and a duplexer.

The memory 2509 may be configured to store software programs or instructions and various data. The memory 2509 may include first storage area for storing programs or instructions and a second storage area for storing data. The first storage area may store an operating system, an application program or instruction required by at least one function (for example, a sound playback function or an image playback function), and the like. In addition, the memory 2509 may include either a volatile memory or a non-volatile memory, or the memory 2509 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch Link DRAM, SLDRAM), and a direct rambus random access memory (Direct Rambus RAM, DRRAM). The memory 2509 in this embodiment of this application includes but is not limited to these and any other suitable types of memories.

The processor 2510 may include one or more processing units. Optionally, an application processor and a modem processor are integrated in the processor 2510. The application processor primarily processes operations relating to an operating system, user interfaces, application programs, and the like. The modem processor primarily processes radio communication signals, for example, being a baseband processor.

It can be understood that the modem processor may alternatively be not integrated in the processor 2510.

The processor 2510 is configured to determine a transmission direction of a first transmission resource based on a first transmission direction of a first transmission, where the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

Optionally, the first transmission is an uplink transmission dynamically scheduled or semi-statically configured, and the first transmission resource is a downlink subband semi-statically configured; or
the first transmission is a downlink transmission dynamically scheduled or semi-statically configured, and the first transmission resource is an uplink subband semi-statically configured; or
the first transmission is an uplink transmission dynamically scheduled or semi-statically configured, and the first transmission resource is a downlink slot or downlink symbol semi-statically configured; or
the first transmission is a downlink transmission dynamically scheduled or semi-statically configured, and the first transmission resource is an uplink slot or uplink symbol semi-statically configured.

Optionally, the processor 2510 is configured to:
in a case that the first transmission direction is different from the second transmission direction, determine a transmission direction of a first part of the first transmission resource as the first transmission direction, and determine a transmission direction of a second part of the first transmission resource as the second transmission direction; where
the first part of the resource is a resource, overlapping the first transmission, in the first transmission resource, and the second part of the resource is a resource, not overlapping the first part of the resource, in the first transmission resource.

Optionally, the processor 2510 is configured to perform the first transmission on the first transmission resource.

Optionally, the processor 2510 is configured to: obtain first indication information, where the first indication information is used to indicate whether the terminal is allowed to change the transmission direction of the first transmission resource based on the first transmission; and
in a case that the first indication information indicates that the terminal is allowed to change the transmission direction of the first transmission resource based on the first transmission, determine the transmission direction of the first transmission resource based on the first transmission direction of the first transmission.

Optionally, the processor 2510 is configured to determine, based on the first transmission direction of the first transmission, the transmission direction of the first transmission resource within a first time window configured by a network-side device.

Optionally, the processor 2510 is configured to:
determine the transmission direction of the first transmission resource, based on the transmission direction configured by the network-side device for the first transmission resource, outside the first time window configured by the network-side device.

Optionally, the processor 2510 is configured to determine a transmission direction of a time-domain resource after a first transmission symbol as the first transmission direction, where the first transmission symbol is a starting symbol of the first transmission; or
determine a transmission direction of a time-domain resource after a second transmission symbol as the first transmission direction, where the second transmission symbol is a starting symbol of a physical downlink control channel PDCCH that schedules the first transmission; or
determine a transmission direction of a time-domain resource after a first transmission position as the first transmission direction, where the first transmission position is a position that is a first duration after the second transmission symbol.

In this embodiment of this application, the terminal determines a transmission direction of a first transmission resource based on a first transmission direction of a first transmission, where the first transmission is a transmission configured or scheduled by a network-side device on the first transmission resource.

In this embodiment of this application, the transmission direction of the first transmission resource may be flexibly determined based on the first transmission direction of the first transmission, rather than being a fixed transmission direction. In this way, the transmission direction of the first transmission resource may be flexibly adjusted according to the service, increasing the resource utilization rate.

An embodiment of this application further provides a readable storage medium, where the readable storage medium stores a program or instructions, and when the program or instructions are executed by a processor, the processes of the foregoing transmission processing method embodiments can be implemented, with same technical effects achieved. To avoid repetition, details are not described herein again.

The processor is a processor in the terminal described in the foregoing embodiment.

The readable storage medium includes a computer-readable storage medium such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instructions to implement the processes of the foregoing transmission processing method embodiment, with the same technical effects achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and the computer program/program product is executed by at least one processor to implement the processes of the foregoing transmission processing method embodiments, with the same technical effects achieved. To avoid repetition, details are not described herein again.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element.

Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined.

In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. However, in many cases, the former is a preferred implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A transmission processing method, comprising:
determining, by a terminal, a transmission direction of a first transmission resource based on a first transmission direction of a first transmission, wherein the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

2. The method according to claim 1, wherein the first transmission is an uplink transmission dynamically scheduled or semi-statically configured, and the first transmission resource is a downlink subband semi-statically configured; or
the first transmission is a downlink transmission dynamically scheduled or semi-statically configured, and the first transmission resource is an uplink subband semi-statically configured; or
the first transmission is an uplink transmission dynamically scheduled or semi-statically configured, and the first transmission resource is a downlink slot or downlink symbol semi-statically configured; or
the first transmission is a downlink transmission dynamically scheduled or semi-statically configured, and the first transmission resource is an uplink slot or uplink symbol semi-statically configured.

3. The method according to claim 1, wherein the determining, by a terminal, a transmission direction of a first transmission resource based on a first transmission direction of a first transmission comprises:
in a case that the first transmission direction is different from the second transmission direction, determining a transmission direction of a first part of the first transmission resource as the first transmission direction, and determining a transmission direction of a second part of the first transmission resource as the second transmission direction; wherein
the first part of the resource is a resource, overlapping the first transmission, in the first transmission resource, and the second part of the resource is a resource, not overlapping the first part of the resource, in the first transmission resource.

4. The method according to claim 3, wherein after the determining a transmission direction of a first part of the first transmission resource as the first transmission direction, the method further comprises:
performing, by the terminal, the first transmission on the first transmission resource.

5. The method according to claim 1, wherein the determining, by a terminal, a transmission direction of a first transmission resource based on a first transmission direction of a first transmission comprises:
obtaining first indication information, wherein the first indication information is used to indicate whether the terminal is allowed to change the transmission direction of the first transmission resource based on the first transmission; and
in a case that the first indication information indicates that the terminal is allowed to change the transmission direction of the first transmission resource based on the first transmission, determining the transmission direction of the first transmission resource based on the first transmission direction of the first transmission.

6. The method according to claim 1, wherein the determining, by a terminal, a transmission direction of a first transmission resource based on a first transmission direction of a first transmission comprises:
determining, based on the first transmission direction of the first transmission, the transmission direction of the first transmission resource within a first time window configured by the network-side device.

7. The method according to claim 6, further comprising:
determining the transmission direction of the first transmission resource, based on the transmission direction configured by the network-side device for the first transmission resource, outside the first time window configured by the network-side device.

8. The method according to claim 1, wherein the determining, by a terminal, a transmission direction of a first transmission resource based on a first transmission direction of a first transmission comprises:
determining a transmission direction of a time-domain resource after a first transmission symbol as the first transmission direction, wherein the first transmission symbol is a starting symbol of the first transmission; or
determining a transmission direction of a time-domain resource after a second transmission symbol as the first transmission direction, wherein the second transmission symbol is a starting symbol of a physical downlink control channel PDCCH that schedules the first transmission; or
determining a transmission direction of a time-domain resource after a first transmission position as the first transmission direction, wherein the first transmission position is a position that is a first duration after the second transmission symbol.

9. A transmission processing apparatus, applied to a terminal and comprising: a processor and a memory, wherein the memory stores a program or instructions capable of running on the processor, and when the program or the instructions are executed by the processor, the processor is configured to:
determine a transmission direction of a first transmission resource based on a first transmission direction of a first transmission, wherein the first transmission is a transmission configured or scheduled by a network-side device on the first transmission resource; and
the first transmission direction is different from a second transmission direction configured for the first transmission resource by the network-side device; or the network-side device has not configured a first transmission direction for the first transmission resource.

10. The apparatus according to claim 9, wherein the first transmission is an uplink transmission dynamically scheduled or semi-statically configured, and the first transmission resource is a downlink subband semi-statically configured; or
the first transmission is a downlink transmission dynamically scheduled or semi-statically configured, and the first transmission resource is an uplink subband semi-statically configured; or
the first transmission is an uplink transmission dynamically scheduled or semi-statically configured, and the first transmission resource is a downlink slot or downlink symbol semi-statically configured; or
the first transmission is a downlink transmission dynamically scheduled or semi-statically configured, and the first transmission resource is an uplink slot or uplink symbol semi-statically configured.

11. The apparatus according to claim 9, wherein the processor is further configured to: in a case that the first transmission direction is different from the second transmission direction, determine a transmission direction of a first part of the first transmission resource as the first transmission direction, and determine a transmission direction of a second part of the first transmission resource as the second transmission direction; wherein
the first part of the resource is a resource, overlapping the first transmission, in the first transmission resource, and the second part of the resource is a resource, not overlapping the first part of the resource, in the first transmission resource.

12. The apparatus according to claim 11, wherein the processor is further configured to:
perform the first transmission on the first transmission resource after the first determining module determines a transmission direction of a first part of the first transmission resource as the first transmission direction.

13. The apparatus according to claim 9, wherein the processor is further configured to:
obtain first indication information, wherein the first indication information is used to indicate whether the terminal is allowed to change the transmission direction of the first transmission resource based on the first transmission; and
in a case that the first indication information indicates that the terminal is allowed to change the transmission direction of the first transmission resource based on the first transmission, determine the transmission direction of the first transmission resource based on the first transmission direction of the first transmission.

14. The apparatus according to claim 9, wherein the processor is further configured to determine, based on the first transmission direction of the first transmission, the transmission direction of the first transmission resource within a first time window configured by the network-side device.

15. The apparatus according to claim 14, wherein the processor is further configured to:
determine the transmission direction of the first transmission resource, based on the transmission direction configured by the network-side device for the first transmission resource, outside the first time window configured by the network-side device.

16. The apparatus according to claim 9, wherein the processor is further configured to:
determine a transmission direction of a time-domain resource after a first transmission symbol as the first transmission direction, wherein the first transmission symbol is a starting symbol of the first transmission; or
determine a transmission direction of a time-domain resource after a second transmission symbol as the first transmission direction, wherein the second transmission symbol is a starting symbol of a physical downlink control channel PDCCH that schedules the first transmission; or
determine a transmission direction of a time-domain resource after a first transmission position as the first transmission direction, wherein the first transmission position is a position that is a first duration after the second transmission symbol.

17. A non-transitory computer-readable storage medium storing a program or instructions, and when the program or instructions are executed by a processor, the transmission processing method according to claim 1 are implemented.

18. A chip, wherein the chip comprises a processor and a communication interface, the communication interface is coupled to the processor, and the processor is configured to run a program or instructions to implement the steps of the transmission processing method according to claim 1.

19. A computer program product, wherein the program product is stored in a non-transitory storage medium, and the program product is executed by at least one processor to implement the steps of the transmission processing method according to claim 1.

20. A terminal, comprising a processor and a communication interface, wherein the processor is configured to implement the steps of the transmission processing method according to claim 1.
